(19) United States
(12) Patent Application Publication
(10) Pub. No.: US 2015/0163053 A1
(43) Pub. Date: Jun. 11, 2015

(54) RELAY APPARATUS, METHOD, AND SYSTEM

(71) Applicant: FUJITSU LIMITED, Kawasaki-shi (JP)

(72) Inventors: Tetsuya Izu, London (GB); Masahiko Takenaka, Kawasaki (JP)

(73) Assignee: FUJITSU LIMITED, Kawasaki-shi (JP)

(21) Appl. No.: 14/625,084

(22) Filed: Feb. 18, 2015

Related U.S. Application Data
(63) Continuation of application No. PCT/JP2012/005276, filed on Aug. 23, 2012.

(51) Int. Cl. H04L 9/08; H04L 29/06

(52) U.S. Cl. CPC H04L 9/0816; H04L 63/0428; H04L 2209/24

(57) ABSTRACT

A relay apparatus includes: a memory; and one or more processors coupled to the memory and configured to: generate second encrypted data by performing a second encryption process using a second key shared with a providing destination apparatus in a second network on first encrypted data which is generated by a node apparatus in a first network performing a first encryption process using a first key on data, generate decrypted data by performing a decryption process using the first key on the second encrypted data, and transmit the decrypted data to the providing destination apparatus.

### CROSS-REFERENCE TO RELATED APPLICATION

This application is a continuation application of International Application PCT/JP2012/005276 filed on Aug. 23, 2012, the entire contents of which are incorporated herein by reference.

### FIELD

The technique disclosed in the present specification is related to a technique of performing relay of encrypted information.

### BACKGROUND

There is a sensor network which can extract an environment or physical circumstances by collecting data from a plurality of wireless terminal stations distributed in a space. In the sensor network, a terminal station having a wireless communication function is called a node. A protocol for ad hoc communication may be employed in the wireless communication in the sensor network.

A sensor network system includes a plurality of nodes and a collecting apparatus which collects data. The sensor network system may further include a sink node such as a gateway. A sensing result in each node is transmitted to the collecting apparatus via the sink node. In addition, the collecting apparatus accumulates information received from each node.

For example, an ad hoc type sensor network system may be applied to a metering system. As the metering system, a node which can perform wireless communication is incorporated into a power meter of each household, and thus a system of a power company can collect a power consumption amount of each household via an ad hoc network. In the metering system, a packet including a power consumption amount of each household detected by each power meter is transmitted from each node to the system of the power company.

The information transmitted from each node is preferably encrypted from the viewpoint of security. The collecting apparatus can select whether or not encrypted data sent from the nodes in the above-described manner is accumulated after being decrypted or is accumulated in an encrypted state. Generally, received information is accumulated in a storage device in an encrypted state from the viewpoint of security and a reduction in a processing load.

Japanese Laid-open Patent Publication No. 2007-272295 is an example of the related art.

### SUMMARY

According to an aspect of the invention, a relay apparatus includes: a memory; and one or more processors coupled to the memory and configured to: generate second encrypted data by performing a second encryption process using a second key shared with a providing destination apparatus in a second network on first encrypted data which is generated by a node apparatus in a first network performing a first encryption process using a first key on data, generate decrypted data by performing a decryption process using the first key on the second encrypted data, and transmit the decrypted data to the providing destination apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one Example of a sensor network system.

FIG. 2 is a functional block diagram of a node.

FIG. 3 illustrates a data configuration example of a sensor data packet.

FIG. 4 is a functional block diagram of a relay apparatus.

FIG. 5 is a data configuration example of a policy storage unit.

FIG. 6 is a data configuration example of a node shared key storage unit.

FIG. 7 is a data configuration example of a providing destination shared key storage unit.

FIG. 8 is a functional block diagram of a collecting apparatus.

FIG. 9 is a data configuration example of a sensor data storage unit.

FIG. 10 is a flowchart illustrating a transmission process of a sensor data packet in the node.

FIG. 11 is a flowchart illustrating a relay process in the relay apparatus and a process in the collecting apparatus.

FIG. 12 is a flowchart illustrating first Example of a providing data generation process.

FIG. 13 is a flowchart illustrating second Example of the providing data generation process.

FIG. 14 is a flowchart illustrating a process in a providing destination.

FIG. 15 is a diagram for explaining an effect of the present example.

FIG. 16 illustrates another Example of the sensor network system.

FIG. 17 is a functional block diagram of a first relay apparatus and a second relay apparatus.

FIG. 18 is a flowchart illustrating a relay process in another Example.

FIG. 19 illustrates a hardware configuration example of the node.

FIG. 20 illustrates a hardware configuration example of the relay apparatus, the first relay apparatus, or the second relay apparatus.

### DESCRIPTION OF EMBODIMENT

Information received from each node in the sensor network system may be provided to another apparatus outside the sensor network system. For example, the information may be provided as information for analysis which is asked of an agent who manages another apparatus or information for work which is entrusted to an agent who manages another apparatus.

In a case where information is provided to another apparatus, the information is preferably encrypted in communication between the sensor network system and another apparatus from the viewpoint of security.

When each node transmits information to the collecting apparatus, the information may be encrypted with a key which is shared in advance between the collecting apparatus and each node. A subject having the key can decrypt the encrypted information. In a case where information received from each node is provided to another apparatus, in order for another apparatus to decrypt the information, the key which is shared in advance between the collecting apparatus and each node may be shared with another apparatus.

However, from the viewpoint of security, it is not preferable that the key which is shared in advance between the collecting apparatus and each node is shared with another apparatus outside the sensor network. However, before information is provided to another apparatus, the provided information has to be processed so that another apparatus can decrypt the information.

Therefore, the present example is directed to performing relay for improving security.

Hereinafter, with reference to the accompanying drawings, an embodiment of a node, a communication method, and a system according to this disclosure will be described in detail.

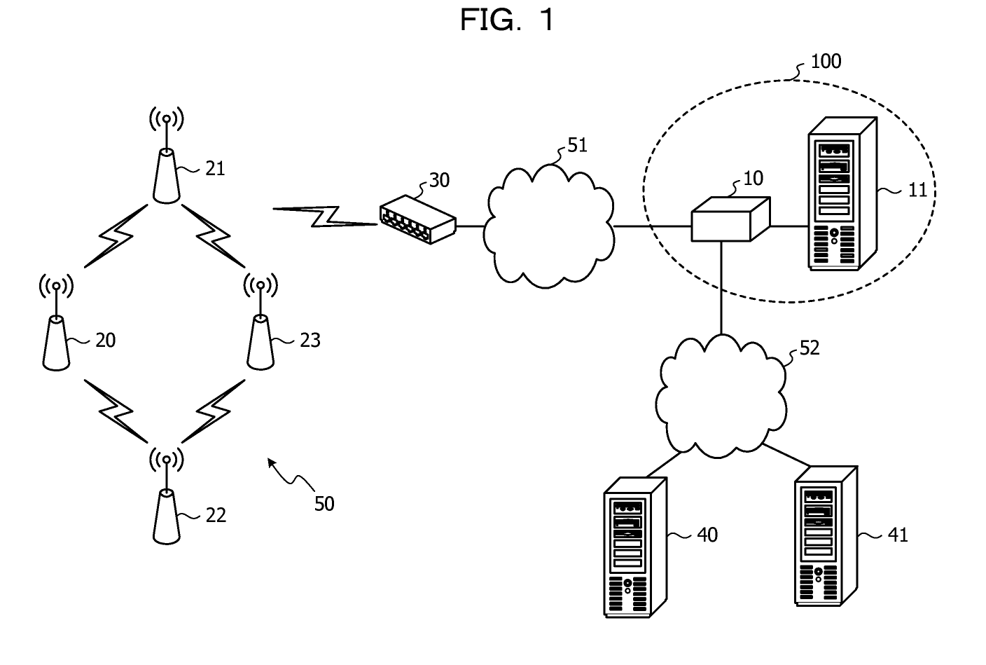

FIG. 1 illustrates one Example of a sensor network system according to an embodiment. The sensor network system includes a plurality of nodes 20, 21, 22 and 23, a sink node 30, and a collecting system 100. FIG. 1 also illustrates computers 40 and 41 which are information providing destinations, but, in the present example, the providing destinations 40 and 41 are computers outside the sensor network system.

Hereinafter, in a case where the plurality of nodes 20 to 23 do not have to be differentiated from each other, the node 20 will be described as a representative thereof.

The node 20 performs communication of a sensor data packet with other nodes which are present within a communicable range with the node 20. In addition, the node 20 is an apparatus which has a sensor and a wireless communication function. Further, the node 20 may be a computer such as a portable terminal.

In the present embodiment, the node 20 is assumed to perform ad hoc communication. The node 20 performs communication of a sensor data packet including sensor data acquired from the sensor, via an ad hoc network 50. In the present embodiment, the sensor data included in the sensor data packet is encrypted.

An existing protocol may be used as a communication protocol related to ad hoc communication. In addition, the technique disclosed in the present example may be realized by using not only the ad hoc communication but also other wireless communication methods.

The sink node 30 is coupled to the collecting system 100 via a network 51 (hereinafter, referred to as a normal network) such as the Internet, a LAN, or a WAN. The sink node 30 performs communication by converting a protocol of information between the ad hoc network 50 and the normal network 51.

The collecting system 100 includes a relay apparatus 10 and a collecting apparatus 11. The collecting apparatus 11 is a computer which manages the sensor network system. The collecting apparatus 11 collects sensor data transmitted from each node and accumulates the sensor data. In addition, the collecting apparatus 11 may give various commands to the node 20 via the sink node 30. For example, the collecting apparatus 11 is a server.

The relay apparatus 10 is a computer which relays sensor data transmitted from the node 20 to the collecting apparatus 11. The relay apparatus 10 generates providing data which is provided to the providing destination 40 or 41 and transmits the providing data thereto. The providing data is data which can be decrypted in the providing destination 40 or 41 and includes at least part of sensor data received from the node. In addition, the collecting apparatus 11 may have a function of the relay apparatus 10.

For example, the relay apparatus 10 receives encrypted sensor data from the node 20 via the sink node 30. In addition, the relay apparatus 10 generates providing data. The relay apparatus 10 may provide the providing data to a providing destination in real time when receiving the sensor data from the node 20.

In addition, as a modification example, the relay apparatus 10 may acquire encrypted sensor data stored in the collecting apparatus 11 from the collecting apparatus 11 and may generate providing data. As mentioned above, the relay apparatus 10 may provide providing data to the providing destination at predetermined timing.

The collecting system 100 is coupled to the providing destinations 40 and 41 via a normal network 52. The providing destinations 40 and 41 are computers which decrypt encrypted providing data. In addition, the providing destinations 40 and 41 perform a predefined process by using the decrypted providing data. Further, in a case where the providing destinations 40 and 41 do not have to be differentiated from each other, the providing destination 40 will be described as a representative of the providing destinations 40 and 41.

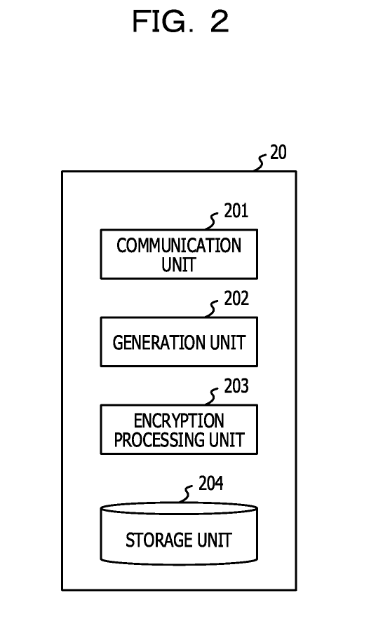

FIG. 2 is a functional block diagram of the node 20. The node 20 includes a communication unit 201, a generation unit 202, an encryption processing unit 203, and a storage unit 204.

The communication unit 201 transmits a sensor data packet. In addition, the communication unit 201 receives a sensor data packet from another node via the ad hoc network 50. The sensor data packets received in the above-described manner may be transmitted along a transmission path.

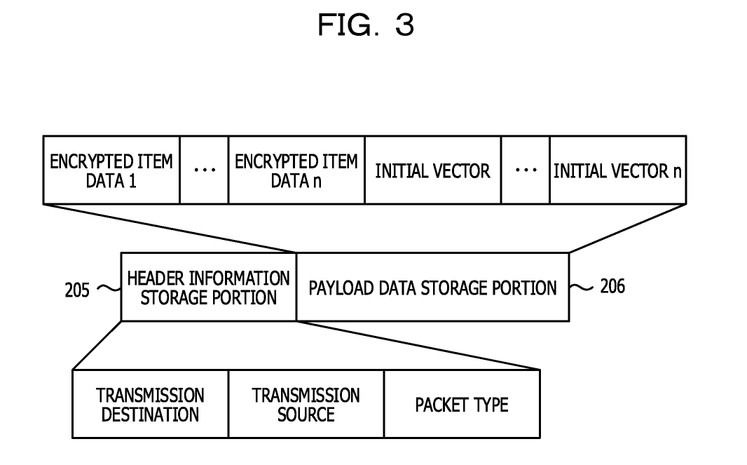

The generation unit 202 generates a sensor data packet. FIG. 3 illustrates a data configuration example of the sensor data packet. The sensor data packet has a header information storage portion 205 and a payload data storage portion 206.

The header information storage portion 205 stores header information. The header information includes transmission destination information, transmission source information, and a packet type. The transmission destination information is information regarding a transmission destination of a sensor data packet. For example, the transmission destination information is an address of a transmission destination. The transmission source information is information regarding a transmission source of a sensor data packet. For example, the transmission source information is an address of a transmission source. The packet type is identification information indicating the type of corresponding packet. For example, in a case of a sensor data packet, “1” indicating the sensor data packet is set as the packet type.

In the ad hoc communication, a packet is transmitted from a start point to an end point through multi-hop communication based on a path which is routed in advance. Therefore, the transmission destination information includes information regarding an end point, and information regarding a transmission destination in one communication piece among multi-hop communication pieces.

For example, in a case where a final transmission destination of a sensor data packet is the sink node 30, an address of the sink node 30 is included in the transmission destination information as information regarding an end point. In addition, an address of another node which the next transmission destination of the sensor data packet is also included in the transmission destination information.

Further, in the ad hoc communication, the transmission source information includes information regarding a start point, and information regarding a transmission source in one communication piece among multi-hop communication pieces. In other words, in a case where a sensor data packet is transmitted, the transmission source information includes an address of a node which generates sensor data included in the sensor data packet and an address of a node which transmits the sensor data packet in certain communication.

The payload data storage portion 206 stores sensor data and an initial vector group. The sensor data includes a plurality of encrypted item data pieces. The item data is information of each of a plurality of items forming the sensor data. For example, the plurality of items include a place where each node is installed, the name of a householder, a power consumption amount, a target period, an IP address, and the like. In addition, the plurality of item data pieces include information regarding a place where each node is installed, information regarding the name of a householder, information regarding a power consumption amount, information regarding a target period, information regarding an IP address, and the like.

The initial vector group is information including a plurality of initial vectors used when each item data piece is encrypted. Details of the initial vector will be described in a process performed by the encryption processing unit. In the payload data storage portion 206, item data pieces 1 to n and initial vectors 1 to n are sequentially stored from 1 to n.

The generation unit 202 generates a sensor data packet by storing various information pieces in the header information storage portion 205 and the payload data storage portion 206.

The encryption processing unit 203 encrypts sensor data. For example, the encryption processing unit 203 generates initial vectors corresponding to the number of items. In addition, random numbers corresponding to the number of items are generated by using a shared key Key_N of the generated initial vector group and the collecting system. The random numbers are generated by using a random number generator.

Further, the encryption processing unit 203 encrypts item data pieces of a plurality of items included in the sensor data by using the random numbers, respectively. For example, the encryption processing unit 203 arithmetically adds the random numbers to the respective item data pieces. Still further, the encryption processing unit 203 performs an exclusive OR on each bit of the item data. The respective item data pieces encrypted by the encryption processing unit 203 and the initial vector group are stored in the payload data storage portion 206 of the sensor data packet by the generation unit 202.

The storage unit 204 stores various information pieces. For example, the storage unit 204 stores the shared key Key_N which is shared with the collecting system. In addition, the storage unit 204 may store a routing table for determining a communication path in the ad hoc communication.

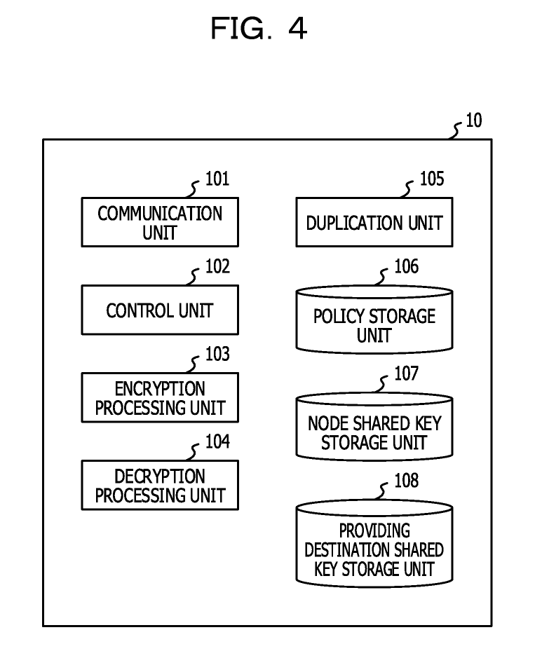

Next, a function of the relay apparatus 10 will be described. FIG. 4 is a functional block diagram of the relay apparatus 10.

The relay apparatus 10 includes a communication unit 101, a control unit 102, an encryption processing unit 103, a decryption processing unit 104, a duplication unit 105, a policy storage unit 106, a node shared key storage unit 107, and a providing destination shared key storage unit 108.

The communication unit 101 receives the encrypted sensor data and the initial vector group from the sink node 30. In addition, the sink node 30 acquires the encrypted sensor data and the initial vector group from the sensor data packet. Further, the sink node 30 the encrypted sensor data and the initial vector group to the relay apparatus 10 of the collecting system 100.

In addition, the communication unit 101 transmits providing data to the providing destination 40. Further, the communication unit 101 transmits the encrypted sensor data and the initial vectors to the collecting apparatus 11.

The control unit 102 puts specific item data in a non-disclosed state based on whether or not each of item data pieces of a plurality of items is disclosed, depending on a providing destination. For example, the control unit 102 deletes non-disclosed item data. In addition, the control unit 102 may conceal the non-disclosed item data. In the present example, as a concealing method, a method of masking non-disclosed item data by using a mask key, or a method of replacing non-disclosed item data with irreversible data by using, for example, hash calculation, may be employed.

Here, it is assumed that the relay apparatus 10 can identify a data portion corresponding to each item among sensor data pieces. For this reason, for example, setting is performed so that a data position as a start point and a data position as an end point are unified between the node, the relay apparatus, and the collecting apparatus.

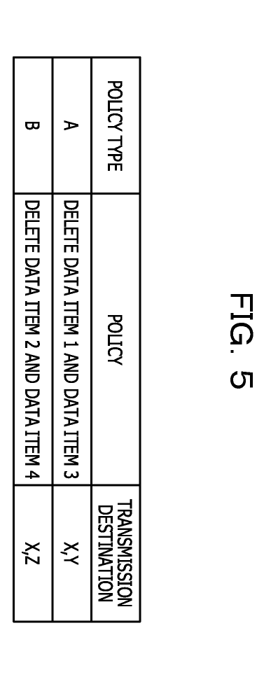

Whether or not each of item data pieces of a plurality of items is disclosed is prescribed by a policy. The policy is stored in the policy storage unit 106. FIG. 5 is a data configuration example of the policy storage unit.

The policy storage unit 106 stores a policy type, a policy, and a providing destination in correlation with each other. The policy type is identification information added to each item of policy content. The policy is information prescribing whether or not each of item data pieces of a plurality of items is disclosed. The providing destination is information regarding a providing destination to which the policy is applied.

In addition, a policy may also be designated for a method for putting data in a non-disclosed state. For example, information such as “deletion of a data item 1 and a data item 3”, or information such as “masking of a data item 5” is set. Further, a policy is not only set to each providing destination, but may also be uniform to all providing destinations. Still further, a policy may be set depending on the type of sensor data.

The control unit 102 acquires one or a plurality of policies corresponding to a providing destination, from the policy storage unit 106. In addition, the control unit 102 sets specific item data in a non-disclosed state based on the policy.

The encryption processing unit 103 encrypts each of item data pieces based on a shared key (hereinafter, referred to as a providing destination shared key) which is shared between the relay apparatus 10 and a providing destination. Here, since each item data piece has been encrypted in advance with the shared key Key_N shared with the node, the encryption with the providing destination shared key indicates that the item data is doubly encrypted.

In the encryption, the encryption processing unit 103 generates a relay initial vector group used for the encryption. In addition, the encryption processing unit 103 generates a plurality of random numbers by using the relay initial vector group and the providing destination shared key. Further, the encryption processing unit 103 further encrypts each of the item data pieces by using the plurality of random numbers.

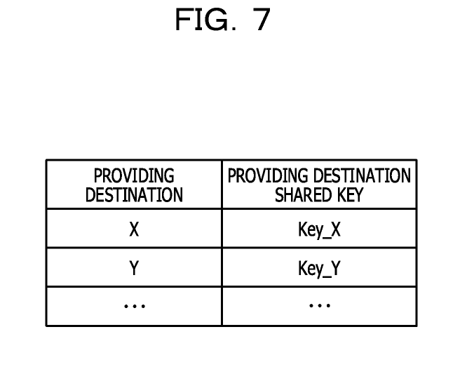

The providing destination shared key is stored in the providing destination shared key storage unit 108. FIG. 7 is a data configuration example of the providing destination shared key storage unit 108.

The providing destination shared key storage unit 108 stores a providing destination and a providing destination shared key in correlation with each other. The providing destination is information for identifying a partner to which at least some data of the sensor data. The providing destination shared key is information regarding a key which is shared in advance with a corresponding providing destination. For example, FIG. 7 illustrates that a key “Key_X” is shared in advance with a providing destination X, and providing data which is provided to the providing destination X is encrypted with the key Key_X.

The decryption processing unit 104 performs a decryption process on the encryption performed in the node by using a node shared key after the encryption process using the providing destination shared key is finished. In other words, the decryption processing unit 104 removes the encryption in the node from each item data piece which is doubly encrypted by the encryption processing unit 103, so that each of the item data pieces is set in a state of being encrypted with the providing destination shared key.

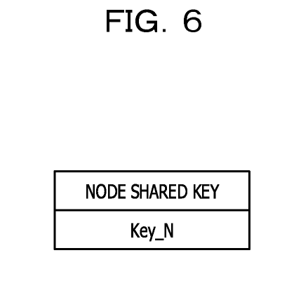

The node shared key is stored in the node shared key storage unit 107. FIG. 6 illustrates a data configuration example of the node shared key storage unit 107.

The node shared key storage unit 107 stores a node shared key Key_N. In addition, in a case where a different shared key for each node is used in encryption in the node, a node shared key for each node may be stored. Further, the node shared key Key_N is the same as the shared key Key_N with the collecting system, stored in the storage unit 204 of the node. The decryption processing unit 104 acquires the node shared key from the node shared key storage unit 107, and performs a decryption process.

As mentioned above, the sensor data which has a plurality of item data pieces and is encrypted in advance is encrypted by the encryption processing unit 103 according to a providing destination. Then, the decryption processing unit 104 removes the encryption with the node shared key, and thus the sensor data can be decrypted in the providing destination. In addition, some item data pieces of the sensor data pieces are made not disclosed, and thus data which is not desired in a providing destination can be put in a non-disclosed state. For example, information which is not related to business entrusted to a providing destination or information related to privacy can be set in a non-disclosed state through the operation.

In the present example, the encryption processing unit 103 performs an encryption process after the control unit 102 sets item data of a predetermined item in a non-disclosed state among a plurality of items and then performs an encryption process. However, the control unit 102 may perform a non-disclosure process after the encryption is performed by the encryption processing unit 103, or after decryption is performed by the decryption processing unit 104.

As described above, the control unit 102, the encryption processing unit 103, the decryption processing unit 104 respectively perform processes, and thus providing data is generated. The providing data is data which can be decrypted by a providing destination, and is data of which predetermined item data is set to be non-disclosed among sensor data pieces. The communication unit 101 transmits the generated providing data to a providing destination.

When the communication unit 101 receives the encrypted sensor data and the initial vector group, the duplication unit 105 duplicates the encrypted sensor data and the initial vectors. In addition, the communication unit 101 is instructed to transmit the sensor data and the initial vectors to the collecting apparatus 11.

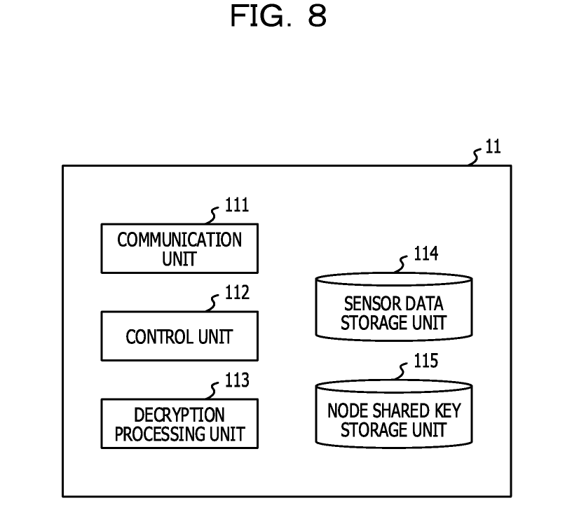

Next, a function of the collecting apparatus 11 will be described. FIG. 8 is a functional block diagram of the collecting apparatus 11. The collecting apparatus 11 includes a communication unit 111, a control unit 112, a decryption processing unit 113, a sensor data storage unit 114, and a node shared key storage unit 115.

The communication unit 111 receives the encrypted sensor data and the initial vector group from the relay apparatus 10. The control unit 112 stores the encrypted sensor data and the initial vectors in the sensor data storage unit 114. In addition, the control unit 112 acquires information from the sensor data storage unit 114 as occasion calls.

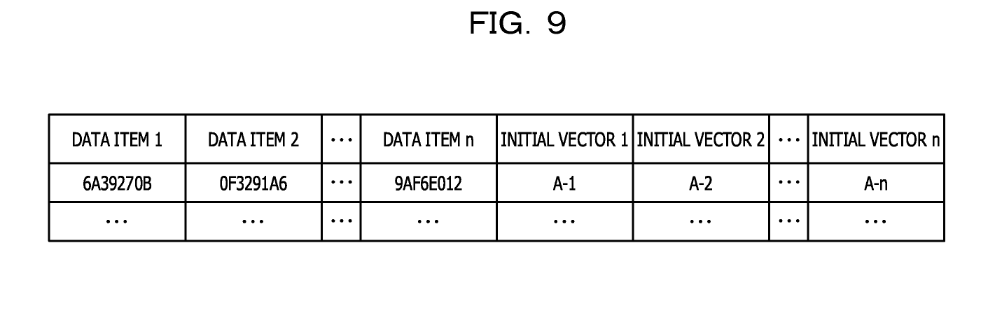

The sensor data storage unit 114 stores the encrypted sensor data and the initial vector group. FIG. 9 illustrates a data configuration example of the sensor data storage unit 114.

The sensor data storage unit 114 stores item data and each data item, and an initial vector used for encryption of each piece of item data.

For example, in a case where data items are present from 1 to n, the sensor data storage unit 114 stores item data pieces of the data items 1 to n. In addition, the sensor data storage unit 114 stores initial vectors 1 to n which are the initial vector group.

The control unit 112 acquires each item data piece m and an initial vector m corresponding to the item data piece m from the sensor data storage unit 114 as occasion calls.

The decryption processing unit 113 decrypts the encrypted item data by using the node shared key Key_N and the initial vector. In addition, the entire sensor data having a plurality of item data pieces may be decrypted by using the initial vector group. Further, the control unit 112 performs various processes by using the decrypted item data.

The node shared key storage unit 115 stores the node shared key Key_N. In addition, a data configuration example is the same as that of the node shared key storage unit 107 of the relay apparatus 10 illustrated in FIG. 6.

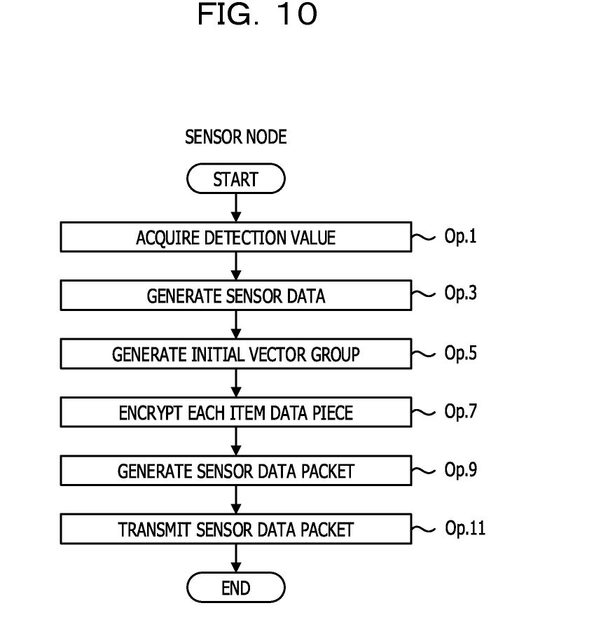

Next, a process in each apparatus will be described. FIG. 10 is a flowchart illustrating a process of transmitting a sensor data packet in the node 20.

The generation unit 202 of the node 20 acquires a detection value from the sensor (Op. 1). The generation unit 202 generates sensor data including the acquired detection value (Op. 3). In addition, the sensor data includes item data of each of a plurality of items. Next, the encryption processing unit 203 generates an initial vector group (Op. 5). The encryption processing unit 203 generates the initial vector group by a preset number of items.

The encryption processing unit 203 encrypts each of the item data pieces by using the initial vector group and the shared key Key_N with the collecting system (Op. 7). Specifically, the encryption processing unit 203 encrypts the item data m by using random numbers which are generated by using the initial vector m and the shared key Key_N. In addition, as described above, the encryption processing unit 203 performs the encryption through arithmetic addition of the random numbers or exclusive OR for each bit.

The generation unit 202 generates a sensor data packet (Op. 9). Specifically, the generation unit 202 stores each of the encrypted item data pieces and the initial vector group in the payload data storage portion 206 of the sensor data packet. In addition, the generation unit 202 generates header information, and stores the header information in the header information storage portion 205 of the sensor data packet. Further, in a case of performing the ad hoc communication, a transmission destination which is an end point and a transmission destination in the next communication are determined by referring to a routing table. Next, the communication unit 201 transmits the sensor data packet to the transmission destination (Op. 11).

Through the above-described process, the sensor data packet is transmitted from the node 20. The sensor data packet is received and protocol-converted by the sink node 30. In addition, the sink node 30 transmits the encrypted sensor data and the initial vector group to the relay apparatus 10 of the collecting system 100.

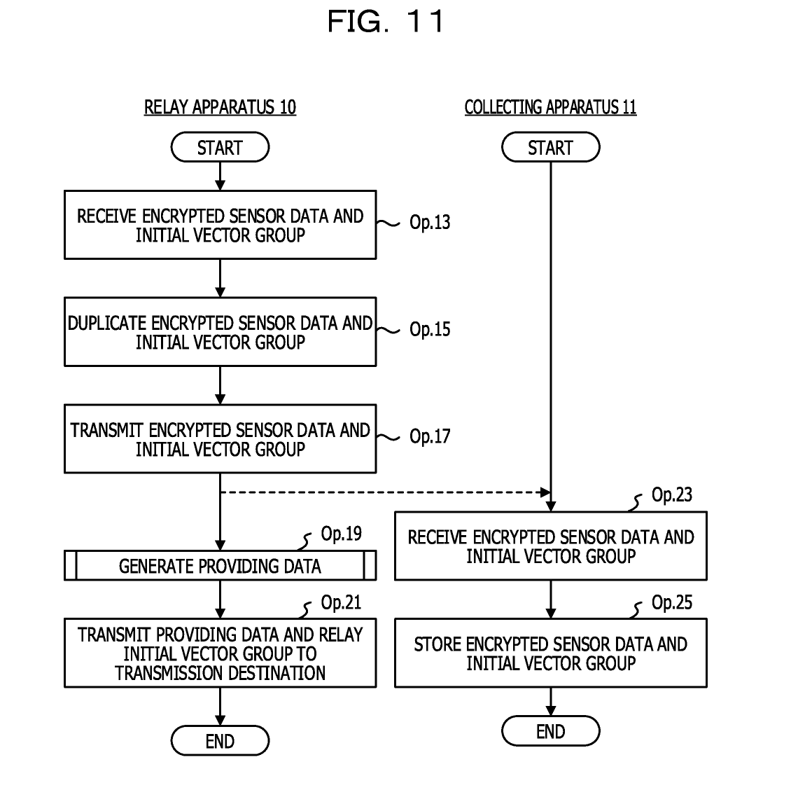

Next, a process in the collecting system 100 will be described. FIG. 11 is a flowchart illustrating a relay process in the relay apparatus 10 and a process in the collecting apparatus.

The communication unit 101 of the relay apparatus 10 receives the encrypted sensor data and the initial vector group from the sink node 30 (Op. 13). The duplication unit 105 duplicates the received sensor data and initial vector group (Op. 15). In addition, the communication unit 101 transmits the duplicated sensor data and initial vector group to the collecting apparatus 11 (Op. 17).

The communication unit 111 of the collecting apparatus 11 receives the encrypted sensor data and the initial vector group (Op. 23). In addition, the control unit 112 stores the encrypted sensor data and the initial vector group in the sensor data storage unit 114 (Op. 25).

In addition, the relay apparatus 10 generates providing data (Op. 19). In addition, the communication unit 101 of the relay apparatus 10 transmits the providing data and the relay initial vector group to a providing destination (Op. 21). Further, in the present example, in a case where the relay apparatus 10 receives the sensor data, the providing data related to the received sensor data is transmitted to a providing destination, but the present example is not limited thereto. For example, the sensor data stored in the collecting apparatus 11 may be acquired at any timing, and providing data may be generated.

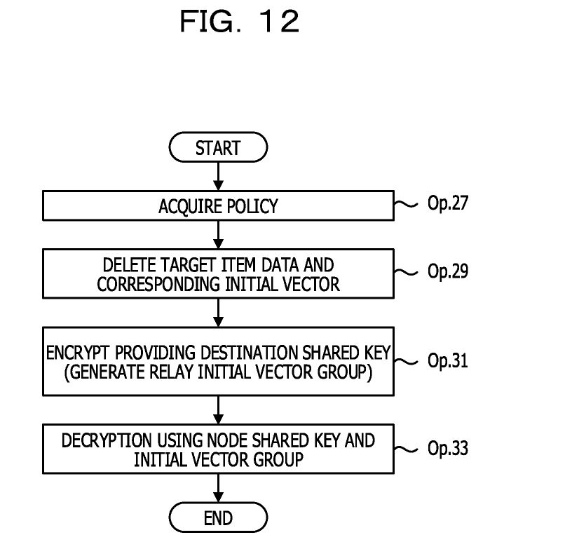

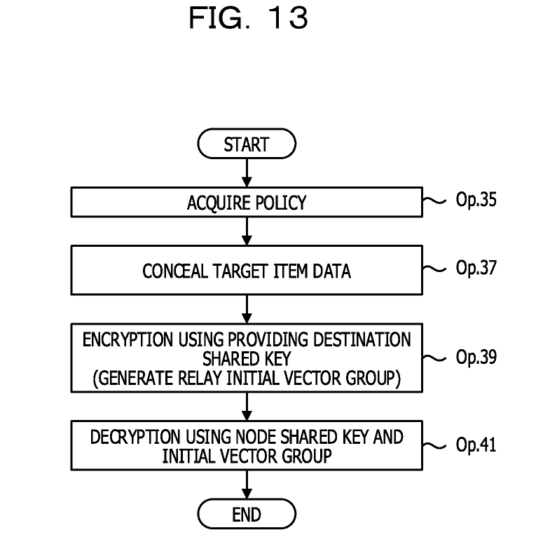

Next, with reference to FIGS. 12 and 13, a providing data generation process will be described. In addition, FIG. 12 is a flowchart illustrating first Example of the providing data generation process. FIG. 13 is a flowchart illustrating second Example of the providing data generation process.

First, a description will be made of the providing data generation process according to first Example. First Example is an example in which predetermined item data is deleted as a method of not disclosing the predetermined item data.

The control unit 102 acquires a policy corresponding to a providing destination from the policy storage unit 106 (Op. 27). In addition, the control unit 102 deletes item data m of a target item, and an initial vector m corresponding to the item data m based on the policy (Op. 29).

Next, the encryption processing unit 103 encrypts remaining item data pieces by using relay initial vectors, and a providing destination shared key acquired from the providing destination shared key storage unit 108 (Op. 31). Specifically, the encryption processing unit 103 generates the relay initial vectors corresponding to the number of remaining item data pieces. In addition, the encryption processing unit 103 generates random numbers corresponding to the number of remaining item data pieces by using the relay initial vectors and the providing destination shared key. Next, the encryption processing unit 103 encrypts the remaining item data pieces by using the generated random numbers.

Next, the decryption processing unit 104 decrypts the remaining item data pieces which are encrypted with the providing destination shared key, by using a node shared key acquired from the node shared key storage unit 107 and a remaining initial vector group (Op. 33). Through the above process, the providing data is generated.

Next, the providing data generation process according to second Example will be described. Second Example is an example in which predetermined item data is concealed as a method of not disclosing the predetermined item data. The concealment includes concealment through masking, and concealment through replacement with irreversible data.

The control unit 102 acquires a policy corresponding to a providing destination from the policy storage unit 106 (Op. 35). In addition, the control unit 102 conceals item data of a target item based on the policy (Op. 37). The control unit 102 masks predetermined item data by using, for example, a mask key.

Next, the encryption processing unit 103 encrypts all item data pieces by using relay initial vectors, and a providing destination shared key acquired from the providing destination shared key storage unit 108 (Op. 39). Specifically, the encryption processing unit 103 generates the relay initial vectors corresponding to the number of item data pieces. In addition, the encryption processing unit 103 generates random numbers corresponding to the number of item data pieces by using the relay initial vectors and the providing destination shared key. Next, the encryption processing unit 103 encrypts the item data by using the generated random numbers.

Next, the decryption processing unit 104 decrypts the item data pieces which are encrypted with the providing destination shared key, by using a node shared key acquired from the node shared key storage unit 107 and the initial vector group (Op. 41). Through the above process, the providing data is generated.

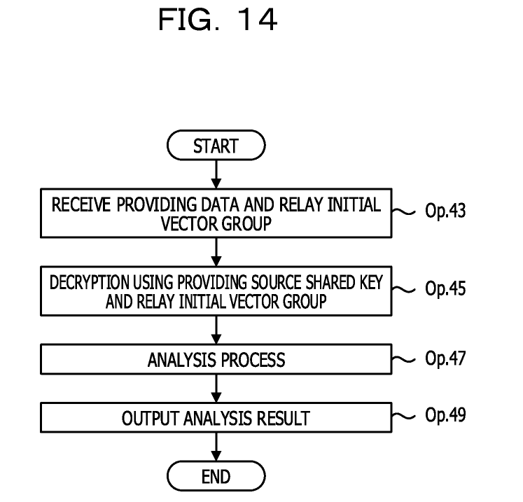

Next, a process in the providing destination 40 will be described. FIG. 14 is a flowchart illustrating a process in the providing destination 40.

The providing destination 40 receives the providing data and the relay initial vector group (Op. 43). In addition, the providing data is data of which only item data disclosed to the providing destination 40 is in a disclosed state among a plurality of item data pieces included in the sensor data. Further, the providing data is encrypted with the providing destination shared key shared between the providing destination 40 and the collecting system 100. The relay initial vectors are used for the encryption.

Next, the providing destination 40 decrypts the providing data by using a providing source shared key and the relay initial vector group (Op. 45). The providing source shared key is a key shared between the providing destination 40 and the collecting system 100, and is the same as the providing destination shared key. In addition, in a case where the providing data includes concealed item data, the concealed item data is not decrypted in the decryption process in Op. 45.

The providing destination 40 performs a predetermined process such as an analysis process by using the providing data which becomes plaintext through decryption (Op. 47). The providing destination 40 outputs an analysis result (Op. 49). For example, the analysis result is transmitted to the collecting system 100. In addition, the analysis result is output to a terminal apparatus which can communicate with the providing destination 40.

The providing destination 40 performs the following analysis by acquiring a plurality of providing data pieces. For example, in a case where the providing data includes information regarding a power consumption amount and a measurement time zone, and further information regarding a region, the providing destination 40 analyzes a power consumption amount for each time zone in each region by using the providing data. In addition, in a case where the providing data includes information for identifying a household, and information regarding a power consumption amount and a measurement period, the providing destination 40 generates a power consumption curve in a certain household by using the providing data.

In addition, in a case where the providing data includes a position of the sensor and an output value of the sensor, the providing destination 40 specifies a place where an abnormal value is detected by using the providing data. For example, in a case where the sensor can measure an amount of sunlight, the providing destination 40 specifies a place where a total amount of sunlight within a predetermined period is smaller than a threshold value.

Through the above-described process, the relay apparatus 10 can generate and provide the providing data to the providing destination. In addition, the collecting apparatus 11 can collect the sensor data and the initial vector group. On the other hand, the providing destination 40 can acquire providing data which can be decrypted with the providing source shared key thereof.

In addition, plaintext sensor data does not appear in the course of providing data being generated by the relay apparatus 10. Therefore, content of the sensor data is maintained in a concealed state to the relay apparatus 10 at all times. In other words, according to the present example, it is possible to generate providing data which can be decrypted by other apparatuses while maintaining security.

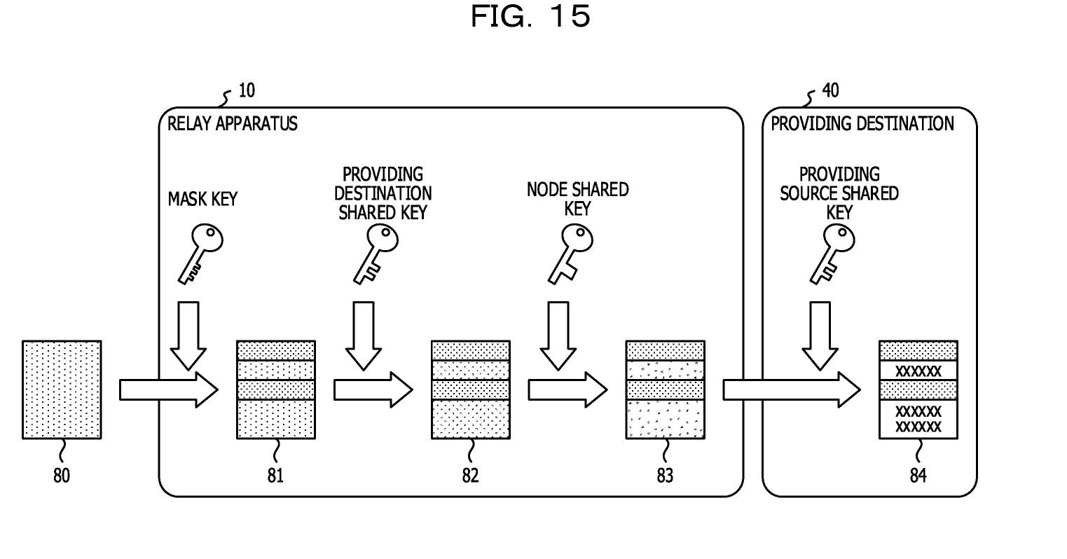

FIG. 15 is a diagram for explaining an effect of the present example. Sensor data 80 has item data pieces all of which are encrypted. In addition, in a case where the relay apparatus 10 acquires the encrypted sensor data 80, the relay apparatus 10 masks some of the item data pieces by using a mask key. In other words, masked sensor data 81 is generated. In addition, here, in order to set specific item data in a non-disclosed state, masking is described as an example, but the specific item data may be set in a non-disclosed state according to the above-described method.

Next, the relay apparatus 10 further encrypts the masked sensor data 81 by using a providing destination shared key. Consequently, sensor data 82 which is doubly encrypted with the mask key and the providing destination shared key.

In addition, the relay apparatus 10 decrypts the sensor data 82 which is doubly encrypted, by using a node shared key. Consequently, providing data 83 is generated. The relay apparatus 10 transmits the providing data 83 to the providing destination 40. The providing destination 40 decrypts the providing data 83 by using a providing source shared key. Further, the providing destination shared key is the same key as the providing source shared key. As mentioned above, the providing destination 40 can acquire plaintext data 84 in which item data other than the item data which is set in a non-disclosed state is disclosed.

As mentioned above, plaintext does not appear in the course of generation of providing data in the relay apparatus 10. In addition, the providing data which is generated in a state of security being maintained is decrypted in the providing destination 40 and undergoes a desired analysis process and the like.

### Modification Example

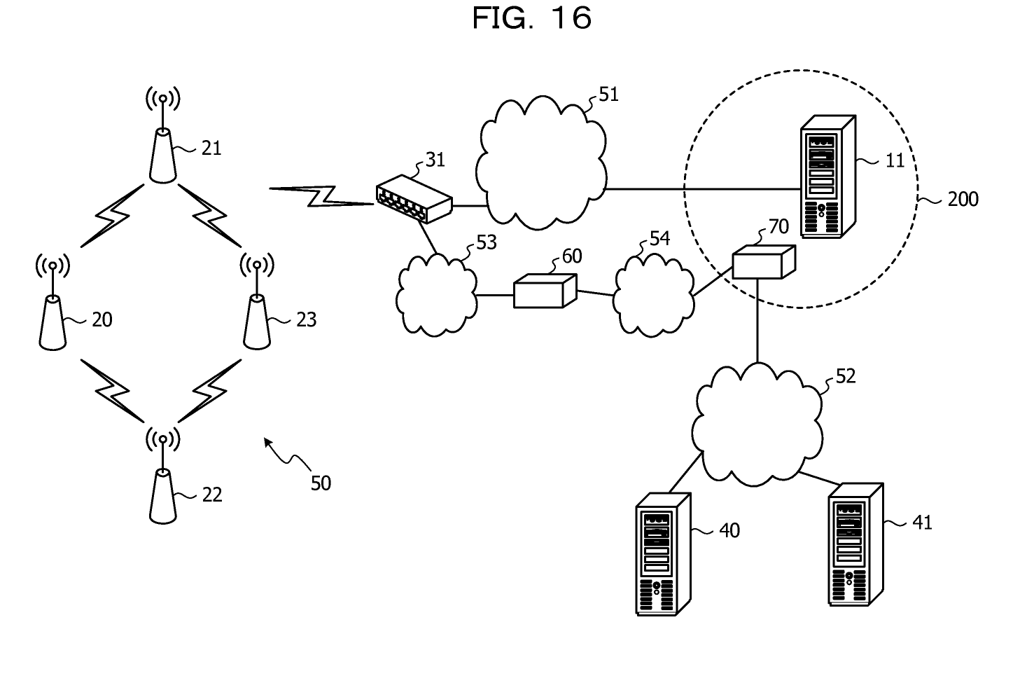

Next, a modification example of the collecting system 100 will be described. FIG. 16 illustrates another Example of the sensor network system. Only a portion different from the sensor network system illustrated in FIG. 1 will be described.

A sink node 31 acquires encrypted sensor data and an initial vector group from a sensor data packet and duplicates the encrypted sensor data and the initial vector group. In addition, the sink node 31 transmits one of the encrypted sensor data and the initial vector group to the collecting apparatus 11 of a collecting system 200, and transmits the other thereof to a first relay apparatus 60.

The first relay apparatus 60 puts specific item data in a non-disclosed state among a plurality of item data pieces included in the sensor data. In addition, the first relay apparatus 60 performs encryption by using a providing destination shared key. A second relay apparatus 70 generates providing data by performing a decryption process using a node shared key. In addition, the second relay apparatus 70 transmits the providing data to the providing destination 40.

The collecting system 200 includes the collecting apparatus 11 and the second relay apparatus 70. The sink node 31 and the first relay apparatus 60 perform communication with each other via a network 53. In addition, the first relay apparatus 60 and the collecting system 200 perform communication via a network 54. Further, a system including the first relay apparatus 60 and the second relay apparatus 70 is referred to as a relay system in some cases.

In the present example, the process of setting specific item data in a non-disclosed state and the encryption using the providing destination shared key are performed in the first relay apparatus 60. The second relay apparatus 70 included in the collecting system 200 may perform the decryption process using the node shared key. In other words, a process load on the second relay apparatus 70 is reduced.

In addition, the node shared key is a key shared between the node 20 and the collecting system 200, and it is not preferable to notify the first relay apparatus 60 of the node shared key in terms of security. Therefore, a decryption process using the node shared key is performed by the second relay apparatus, and thus security can be maintained.

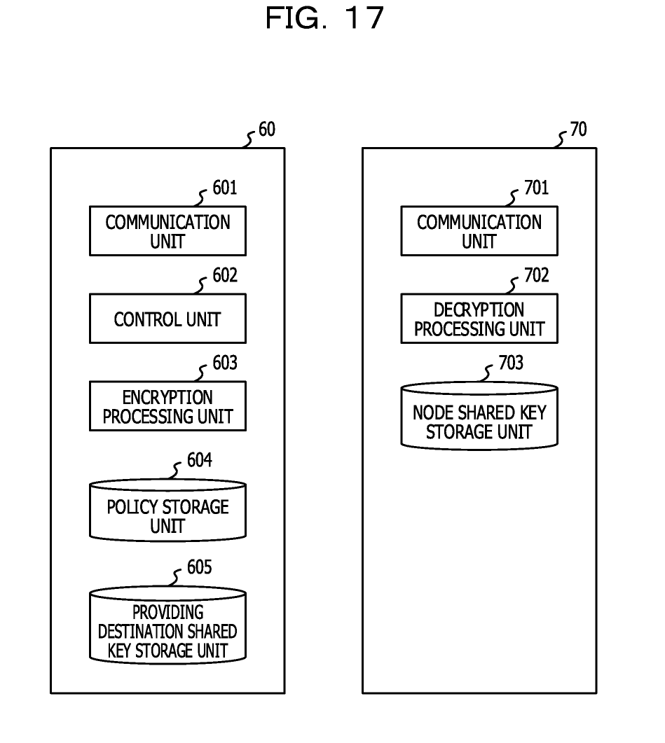

FIG. 17 is a functional block diagram of the first relay apparatus 60 and the second relay apparatus 70. The first relay apparatus 60 includes a communication unit 601, a control unit 602, an encryption processing unit 603, a policy storage unit 604, and a providing destination shared key storage unit 605.

The communication unit 601 receives encrypted sensor data and an initial vector group from the sink node 31. In addition, the communication unit 601 transmits intermediate sensor data and a relay initial vector group to the second relay apparatus 70. The intermediate sensor data is sensor data of which specific item data is set in a non-disclosed state and is encrypted with the providing destination shared key.

The control unit 602 has the same function as that of the control unit 102 of the relay apparatus 10. The encryption processing unit 603 has the same function as that of the encryption processing unit 103 of the relay apparatus 10. The policy storage unit 604 has the same data configuration as that of the policy storage unit 106 of the relay apparatus 10. The providing destination shared key storage unit 605 has the same data configuration as that of the providing destination shared key storage unit 108 of the relay apparatus 10.

The second relay apparatus 70 includes a communication unit 701, a decryption processing unit 702, and a node shared key storage unit 703. The communication unit 701 receives the intermediate sensor data and the relay initial vector group from the first relay apparatus 60. In addition, the communication unit 701 transmits the providing data the relay initial vector group to the providing destination 40.

The decryption processing unit 702 has the same function as that of the decryption processing unit 104 of the relay apparatus 10. The node shared key storage unit 703 has the same data configuration as that of the node shared key storage unit 107 of the relay apparatus 10.

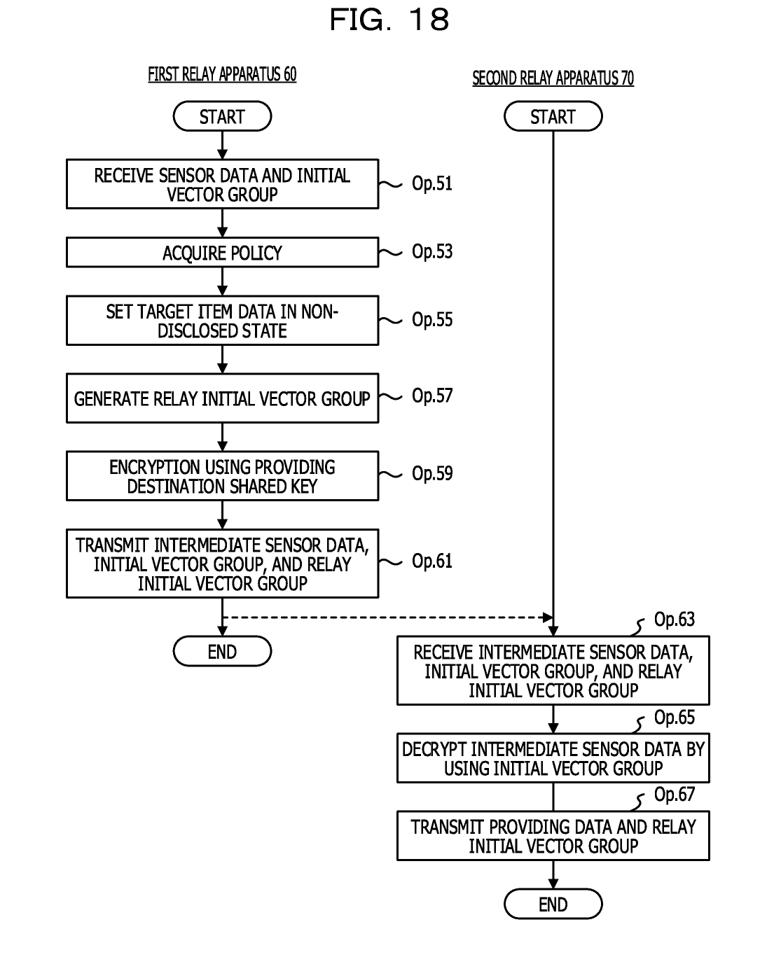

FIG. 18 is a flowchart illustrating a relay process in another Example. The communication unit 601 of the first relay apparatus 60 receives encrypted sensor data and an initial vector group from the sink node 31 (Op. 51). In addition, the control unit 602 acquires a policy corresponding to a providing destination from the policy storage unit 604 (Op. 53).

The control unit 602 sets target item data in a non-disclosed state according to the policy (Op. 55). In a case where the target item data is set in a non-disclosed state through masking, an initial vector used when the masking is performed is transmitted to the second relay apparatus 70 along with intermediate sensor data which will be described later. In a case where unmasking is desired, the second relay apparatus 70 of the collecting system 200 performs the unmasking by using the initial vector which is used in the masking.

Next, the encryption processing unit 603 generates a relay initial vector group (Op. 57). In addition, the encryption processing unit 603 encrypts the sensor data by using the relay initial vector group and a providing destination shared key (Op. 59). The sensor data which is encrypted by the encryption processing unit 603 is intermediate sensor data.

In addition, the communication unit 601 transmits the intermediate sensor data, the initial vector group, and the relay initial vector group to the second relay apparatus 70 (Op. 61).

The communication unit 701 of the second relay apparatus 70 receives the intermediate sensor data, the initial vector group, and the relay initial vector group from the first relay apparatus 60 (Op. 63). In addition, the intermediate sensor data is decrypted by using the initial vector group and the node shared key (Op. 65). Providing data is generated through this decryption. The communication unit 701 transmits the providing data and the relay initial vector group to a providing destination (Op. 67).

Through the above-described process, the first relay apparatus 60 and the second relay apparatus 70 can generate and provide the providing data to a providing destination. In addition, the providing destination can acquire providing data which can be decrypted with a providing source shared key thereof.

In addition, the sensor data does not become plaintext in the course of providing data being generated by the first relay apparatus 60 and the second relay apparatus 70. Therefore, content of the sensor data is maintained in a concealed state to the first relay apparatus 60 and the second relay apparatus 70 at all times. In other words, according to the present example, it is possible to generate providing data which can be decrypted by other apparatuses while maintaining security.

Further, decryption using the node shared key may be performed after encryption using the providing destination shared key is performed, and a process of setting specific item data in a non-disclosed state may be performed at any timing. For example, the process of setting the specific item data in a non-disclosed state may be performed after encryption is performed.

In addition, the first relay apparatus 60 may perform only encryption using the providing destination shared key, and the second relay apparatus 70 may perform decryption using the node shared key and a process of setting specific item data in a non-disclosed state. Also in this case, the process of setting the specific item data in a non-disclosed state may be performed at any timing.

### Hardware Configuration Example

Next, a description will be made of a hardware configuration of each apparatus described in the above plurality of Examples.

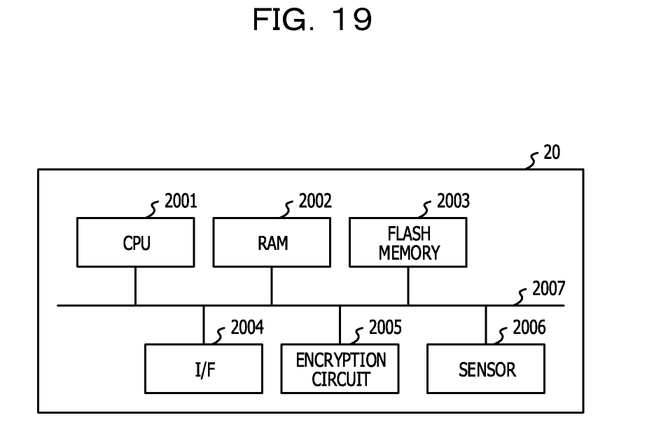

FIG. 19 is a hardware configuration example of the node 20. The node 20 includes a central processing unit (CPU) 2001, a random access memory (RAM) 2002, a flash memory 2003, an interface (I/F) 2004, an encryption circuit 2005, a sensor 2006, and a bus 2007. The CPU 2001, the RAM 2002, the flash memory 2003, the I/F 2004, the encryption circuit 2005, and the sensor 2006 are coupled to each other via the bus 2007.

The CPU 2001 controls the entire node 20. The CPU 2001 functions as the generation unit 202 by executing a program loaded on the RAM 2002.

The RAM 2002 is used as a work area of the CPU 2001. The flash memory 2003 stores a program, various key information pieces, and a routing table. The flash memory 2003 is an example of the storage unit 204. The program includes a program for performing each process in the node, illustrated in the flowchart of FIG. 10. The program stored in the flash memory 2003 is loaded on the RAM 2002 and is executed by the CPU 2001, and thus the node 20 functions as the various processing units described with reference to FIG. 2.

The I/F 2004 receives a packet by using the multi-hop communication. The I/F 2004 is an example of the communication unit 201. The encryption circuit 2005 is a circuit which encrypts data with an encryption key during the encryption of the data. The encryption circuit 2005 is an example of the encryption processing unit 203. In addition, in a case where the encryption is performed in software, the CPU 2001 functions as the encryption processing unit 203. For this reason, the CPU 2001 reads a program corresponding to the encryption circuit 2005 from the flash memory 2003 and executes the program.

The sensor 2006 detects data specific to the sensor 2006. For example, measurement target data is detected, such as a temperature, humidity, a water level, a precipitation, an air volume, a sound volume, a power consumption amount, a gas consumption amount, a use amount of waterworks, a use amount of sewers, time, a time point, and acceleration. The CPU 2001 acquires a detection value from the sensor 2006. In addition, the CPU 2001 transmits the acquired detection value as sensor data.

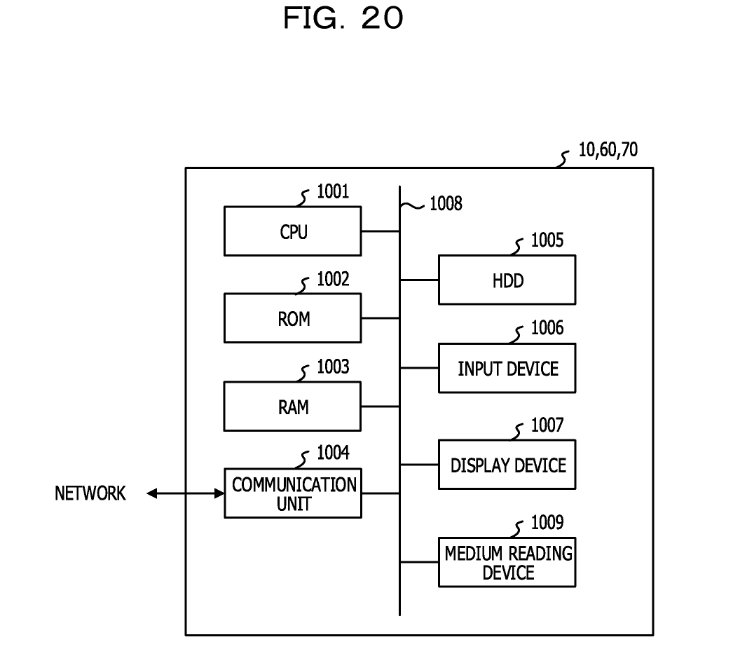

FIG. 20 is a diagram illustrating an example of a hardware configuration of the relay apparatus 10, the first relay apparatus 60, or the second relay apparatus 70. Hereinafter, a description will be made of a hardware configuration of a computer which functions as the relay apparatus 10, the first relay apparatus 60, or the second relay apparatus 70.

The computer includes a central processing unit (CPU) 1001, a read only memory (ROM) 1002, a random access memory (RAM) 1003, a communication device 1004, a hard disk drive (HDD) 1005, a input device 1006, a display device 1007, and a medium reading device 1009, which are coupled to each other via a bus 1008. In addition, the above-described elements can transmit and receive data to and from each other under the control of the CPU 1001.

A program related to a relay process is recorded on a computer readable recording medium. The computer readable recording medium includes a magnetic recording medium, an optical disc, a magneto-optical recording medium, a semiconductor memory, and the like. The magnetic recording medium includes an HDD, a flexible disk (FD), a magnetic tape (MT), and the like. In addition, a program related to the various processes described in Examples is recorded on a computer readable recording medium.

The optical disc includes a digital versatile disc (DVD), a DVD-RAM, a compact disc-read only memory (CD-ROM), a CD-recordable (CD-R)/rewritable (RW), and the like. The magneto-optical recording medium includes a magneto-optical (MO) disk, and the like. In a case where the program is distributed, for example, a portable recording medium such as a DVD or a CD-ROM recording the program thereon may be sold.

In addition, in the computer 1000, for example, the medium reading device 1009 reads programs from a recording medium which records the various programs thereon. The CPU 1001 stores the read programs in the HDD 1005, the ROM 1002, or the RAM 1003.

The CPU 1001 is a central processing unit which controls the overall operation of the relay apparatus 10, the first relay apparatus 60, or the second relay apparatus 70. The HDD 1005 stores a program which causes the computer to realize the same function as the function of the relay apparatus 10, the first relay apparatus 60, or the second relay apparatus 70 described in the above-described respective Examples and causes the computer to perform each process.

In addition, the CPU 1001 reads the program from the HDD 1005 and executes the program so as to function as the control unit 102, the encryption processing unit 103, the decryption processing unit 104, and the duplication unit 105 of the relay apparatus 10 illustrated in FIG. 4. Further, the CPU 1001 reads the program from the HDD 1005 and executes the program so as to function as the control unit 602 and the encryption processing unit 603 of the first relay apparatus 60 illustrated in FIG. 17. The CPU 1001 reads the program from the HDD 1005 and executes the program so as to function as the decryption processing unit 702 of the second relay apparatus 70 illustrated in FIG. 17.

The various programs may be stored in the ROM 1002 or the RAM 1003 which can be accessed by the CPU 1001.

The HDD 1005 functions as at least some of the policy storage unit, the node shared key storage unit, and the providing destination shared key storage unit under the control of the CPU 1001. In the same manner as the program, the information of the storage unit may be stored in the ROM 1002 or the RAM 1003 which can be accessed by the CPU 1001. The ROM 1002 or the RAM 1003 also stores information which is temporarily generated during a process performed by the CPU 1001.

The display device 1007 displays each screen as occasion calls. The communication device 1004 receives a signal from another device via a network and transfers content of the signal to the CPU 1001. In addition, the communication device 1004 transmits a signal to another device via the network in response to an instruction from the CPU 1001. The input device 1006 receives information which is input by a user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A relay apparatus comprising:
a memory; and
one or more processors coupled to the memory and configured to:
generate second encrypted data by performing a second encryption process using a second key shared with a providing destination apparatus in a second network on first encrypted data which is generated by a node apparatus in a first network performing a first encryption process using a first key on data,
generate decrypted data by performing a decryption process using the first key on the second encrypted data, and
transmit the decrypted data to the providing destination apparatus.

2. The relay apparatus according to claim 1, wherein
the first encrypted data includes a plurality of data pieces corresponding to a plurality of items, and
the one or more processors are configured to:
set at least one of the plurality of data pieces in a non-disclosed state based on information indicating whether or not each of the plurality of items is desired to be disclosed to the providing destination apparatus.

3. The relay apparatus according to claim 2, wherein the one or more processors are configured to:
delete the at least one of the plurality of data pieces, so as to set the at least one of the plurality of data pieces in a non-disclosed state.

4. The relay apparatus according to claim 2, wherein the one or more processors are configured to:
perform an encryption process using a third key on the at least one of the plurality of data pieces, so as to set the at least one of the plurality of data pieces in a non-disclosed state.

5. The relay apparatus according to claim 2, wherein the one or more processors are configured to:
replace the at least one of the plurality of data pieces with irreversible information, so as to set the at least one of the plurality of data pieces in a non-disclosed state.

6. The relay apparatus according to claim 1, wherein
the first encrypted data includes a plurality of data pieces corresponding to a plurality of items, and is encrypted for the plurality of data pieces by using a plurality of initial vectors in the first encryption process, and
the one or more processors are configured to:
receive the first encrypted data and the plurality of initial vectors, and
perform the decryption process on the second encrypted data by using the first key and the plurality of initial vectors.

7. A method comprising:
generating, by one or more processors, second encrypted data by performing a second encryption process using a second key shared with a providing destination apparatus in a second network on first encrypted data which is generated by a node apparatus in a first network performing a first encryption process using a first key on data;
generating decrypted data by performing a decryption process using the first key on the second encrypted data; and
transmitting the decrypted data to the providing destination apparatus.

8. The method according to claim 7, wherein
the first encrypted data includes a plurality of data pieces corresponding to a plurality of items, and
the method further comprising:
setting at least one of the plurality of data pieces in a non-disclosed state based on information indicating whether or not each of the plurality of items is desired to be disclosed to the providing destination apparatus.

9. The method according to claim 8, wherein the setting includes deleting the at least one of the plurality of data pieces.

10. The method according to claim 8, wherein the setting includes performing an encryption process using a third key on the at least one of the plurality of data pieces.

11. The method according to claim 8, wherein the setting includes replacing the at least one of the plurality of data pieces with irreversible information.

12. The method according to claim 7, wherein the first encrypted data includes a plurality of data pieces corresponding to a plurality of items, and is encrypted for the plurality of data pieces by using a plurality of initial vectors in the first encryption process, and
the method further comprising:
receiving the first encrypted data and the plurality of initial vectors; and
performing the decryption process on the second encrypted data by using the first key and the plurality of initial vectors.

13. A system comprising:
a node apparatus included in a first network and including a first processor;
a relay apparatus including a second processor; and
a providing destination apparatus in a second network,
wherein the first processor of the node apparatus is configured to:
generate first encrypted data by performing a first encryption process using a first key on data, and
transmit the first encrypted data, and
wherein the second processor of the relay apparatus is configured to:
generate second encrypted data by performing a second encryption process using a second key shared with the providing destination apparatus on the first encrypted data,
generate decrypted data by performing a decryption process using the first key on the second encrypted data, and
transmit the decrypted data to the providing destination apparatus.

14. The system according to claim 13, wherein
the first encrypted data includes a plurality of data pieces corresponding to a plurality of items, and
the second processor of the relay apparatus is configured to:
set at least one of the plurality of data pieces in a non-disclosed state based on information indicating whether or not each of the plurality of items is desired to be disclosed to the providing destination apparatus.

15. The system according to claim 14, wherein the second processor of the relay apparatus is configured to:
delete the at least one of the plurality of data pieces, so as to set the at least one of the plurality of data pieces in a non-disclosed state.

16. The system according to claim 14, wherein the second processor of the relay apparatus is configured to:
perform an encryption process using a third key on the at least one of the plurality of data pieces, so as to set the at least one of the plurality of data pieces in a non-disclosed state.

17. The system according to claim 14, wherein the second processor of the relay apparatus is configured to:
replace the at least one of the plurality of data pieces with irreversible information, so as to set the at least one of the plurality of data pieces in a non-disclosed state.

18. The system according to claim 13, wherein
the first encrypted data includes a plurality of data pieces corresponding to a plurality of items, and is encrypted for the plurality of data pieces by using a plurality of initial vectors in the first encryption process, and
the second processor of the relay apparatus is configured to:
receive the first encrypted data and the plurality of initial vectors, and
perform the decryption process on the second encrypted data by using the first key and the plurality of initial vectors.
